(19) United States
(12) Patent Application Publication
(10) Pub. No.: US 2016/0342854 A1
(43) Pub. Date: Nov. 24, 2016

(54) PILL CUP WITH OPTICAL MARKERS FOR IMPROVED MEDICATION ADHERENCE

(71) Applicants: Richard Whitcomb Loveless, Charlotte, NC (US); Mary Ann Chirba, Waltham, MA (US); Peter Alagona, JR., Harrisburg, PA (US); Gail Alagona Silverstein, Atlanta, GA (US)

(72) Inventors: Richard Whitcomb Loveless, Charlotte, NC (US); Mary Ann Chirba, Waltham, MA (US); Peter Alagona, JR., Harrisburg, PA (US); Gail Alagona Silverstein, Atlanta, GA (US)

(21) Appl. No.: 15/155,042

(22) Filed: May 15, 2016

Related U.S. Application Data
(60) Provisional application No. 62/179,782, filed on May 18, 2015.

(51) Int. Cl. G06K 9/20; G06T 7/40; G06T 7/60; A61J 7/00; A61J 7/02

(52) U.S. Cl. CPC G06K 9/2063; A61J 7/0046; A61J 7/0069; A61J 7/02; G06T 7/60; G06T 7/408; A61J 2205/00; G06T 2207/10024; G06T 2207/30242; G06T 2207/30004; G06T 2207/30204

(57) ABSTRACT

Pill cups are described for containing individual doses of various pills. Per-dose pill cups include locating features for precise placement and alignment on open trays or within outer pill boxes with lids. Individual per-dose pill cups can be contained on or within a plurality of trays or outer pill boxes, providing the option for pills or pill cups to be easily moved from one tray or outer pill box to another. Additionally, each per-dose pill cup has optical markers. These markers can be used to provide fiduciary references or measurements within the field of vision of recorded images, such as photographs, and relative to multiple pills contained within a given per-dose pill cup. Optical markers calibrate analysis of pill size, shape, color, markings, shading, position, and presence or absence within each per-dose pill cup.

### CROSS REFERENCE TO RELATED APPLICATION

The present non-provisional application claims the benefit of commonly assigned provisional application having Ser. No. 62/179,782, filed on May 18, 2015, and entitled DEVICE AND METHOD TO IMPROVE MEDICATION ADHERENCE, which application is incorporated herein by reference in its entirety.

### FIELD OF THE INVENTION

This invention is directed generally to a storage device for pills and, in particular, to apportioned doses of pills which are regularly administered for the medication of users. More specifically, the invention is directed to a device and method for providing favorable ergonomic access to multiple doses of multiple pills for a wide range of users including patients, caregivers, health care providers, and pharmacists. Additionally, the invention is directed to a device with precision features that are essential for accurate pill identification through photography, electronic image recognition, and 3D software reconstruction. Separately and together, these features simplify organization and simultaneous administration of simple and complex dosing regimens while optimizing the collection of accurate, real-time data for the purpose of monitoring adherence and tracking patient response to medication management of one or more acute or chronic conditions.

### BACKGROUND OF THE INVENTION

Most acute and chronic medical conditions involve some form of prescription or over-the-counter medication for initial treatment and ongoing management. This is particularly true for chronic conditions. Approximately 30 percent of Americans (100 million) are affected by multiple chronic illnesses, representing an increase of almost 10 percent since 2001. Each year, 60 percent of the U.S. population or roughly 200 million people are prescribed one or more medications in the form of prescription-only medications, over-the-counter medications, and supplements. The numbers of patients in need of medication and prescriptions per patient will continue to grow due to longer life expectancy, an aging population, the rising incidence of chronic disease, and the growing use of multiple medications to manage acute and chronic illness.

Approximately 100 million people do not adhere to their prescribed regimen for taking the right medications at the right times. Medication nonadherence can cause clinically significant adverse events at the individual level and increase overall rates of morbidity and mortality rates. This creates an estimated societal burden of $290 billion in excess health care spending each year, including $100 billion for potentially avoidable initial hospitalizations and readmissions.

Medication adherence occurs when the patient takes the right pill at the right time. For most patients, the simple act of taking a pill each day is anything but simple. The medication cycle involves multiple steps with multiple parties and more often than not, multiple daily doses of multiple medications overseen by multiple caregivers. The cycle can be broken down as follows: (1) the health care provider prescribes the appropriate medication; (2) the insurer approves coverage; (3) the pharmacist fills the prescription in a correct and timely manner, (4) the patient or caregiver purchases the prescription; (5) the patient or caregiver organizes the pills according to name, number of pills and time of taking, (6) the patient takes the prescription in accordance with the prescribed dosing regimen; (7) the patient persists in taking the medication as intended for the full term of the prescription; and (8) the patient or caregiver refills the prescription before it runs out or expires, and begins the cycle anew.

Each step of this process offers an opportunity for the medication cycle to collapse and medication adherence to fail. Poor adherence is even more likely when the patient suffers from co-morbidities that may complicate the dosing regimen and/or the physical tasks of organizing, remembering, and taking the pill itself. Thus, for any patient in need of medication and especially for the hundreds of millions who need more than one and sometimes a dozen prescription medications each day, the “simple” act of taking a pill actually involves careful coordination and implementation of a multi-variate complex process.

There are many reasons for poor medication adherence, including systemic hurdles (e.g., provider access, provider-pharmacy communication, medication errors) and financial barriers (e.g., uneven insurance coverage and significant patient cost-sharing). These obstacles are sizeable and warrant aggressive mitigation efforts. Overcoming them, however, does little to attack the literal core of medication nonadherence: making pills easy to organize, take, and monitor. More often than not, patients have their medications in-hand, intend to adhere to their provider's prescribed medication regimen, but find that the logistics of doing so are too difficult to follow, especially over an extended period of time.

A growing number of strategies have been employed to improve this form of nonadherence, ranging from pill bottles and pill boxes with built-in alarms for each dose and pharmacy-generated “robo-call” refill reminders, to increasingly complex uses of health information technology (HIT), including—clinical decision support systems (CDSs) and health information exchanges (HIEs) to facilitate information sharing across organizational boundaries; electronic health records (EHRs) to integrate information across multiple providers; laboratories and pharmacies; patient portals to give patients access to personal health records (PHRs); and more.

The expanding role of technology reflects the increasing complexity of medication management of illness, particularly multiple chronic conditions. Ironically, however, not enough has been done to improve medication management and adherence at ground zero of medication adherence—i.e., improving the basic pill box as the foundation of organizing and taking the right medications at the right times. A pill box is of limited utility and value if it is not properly loaded and used throughout the medication cycle. Beyond its ability to facilitate proper loading and distribution of pills, a pill box is under-utilized if it is not designed to permit collection and analysis of real-time data concerning compliance with, or deviation from prescribed dosing regimens. This invention re-conceptualizes pill box design to improve usability and optimize the collection and transmission of available information for multiple uses by multiple parties.

With regard to the physical acts of loading and taking pills, commercially available pill bottles and pill boxes tend to present one or more of the following limitations: (a) they are limited to one day or one week even though medications are prescribed by month; (b) their physical layout may be too simple to accommodate one or more complex dosing regimens; (c) alternatively, their physical layout may be too complicated to use in terms of apportioning, loading and accessing multiple doses of multiple pills over the course of a day or week; (d) notwithstanding such limitations, pill bottles and pill boxes rely on the patient or caregiver to apportion doses and load the box properly instead of the pharmacist or provider, (e) they make it difficult to remove pills from small and immobile per-dose containers; (f) they provide no way to alert the user to take a dose; (g) they provide user alerts but do so in the form of flashing lights or sounds that require physical proximity to the pill box for timely detection; (h) they provide alerts through smart phone apps which may not be “user-friendly” for many users and do nothing to simplify the underlying multiple dosing regiments; (i) they do not accommodate different lifestyles or the need to organize a subset of pills for travel purposes; (j) they do little to collect information concerning proper pill box utilization and medication adherence; and similarly, (k) they do little to communicate that data to health care providers and pharmacies for the purpose of monitoring adherence and tracking the patient's response to prescribed medication treatment and management. In addition, existing pill boxes with built-in electronics come with high costs and complexity, and no guiding standards. Modern vision and image recognition systems have yet to be applied to the medication adherence process, and lean manufacturing methods common to factory processes have not been optimized for personal medication management.

A patient's challenges with medication adherence typically begin with organizing pills, which can be both difficult and tedious. The most prevalent method for organization is to remove pills from pharmacy pill bottles and place each dose into separate pill storage pockets within a pill box. The position of doses within a pill box creates a physical and visual map that corresponds with the time of day for when a next dose needs to be taken. Organizing a month's worth of pills, whether done over the course of a month, week or day, will typically require a patient or caregiver to arrange three or four doses per day for 30 days. This amounts to 120 groups of pills per month for a single medication. Further complicating this process is that most existing pill box designs require more than 120 pill cup lids to be opened and closed in order to place individual doses into individual pill cup locations and later retrieve separate doses for taking. This process would be repeated each time a medication is loaded, taken and refilled.

Organizing a full month of pills in one simple and cohesive process improves the likelihood that a patient will complete the full month of doses with no residual pills left in pharmacy pill bottles. Many existing pill boxes will not permit a full month's supply of pills to be organized at one time. Those that do are organizationally complex and tedious to complete. Consequently, using them requires sustained concentration and repetitive physical manipulations, either or both of which may exceed the patient/caregiver's abilities.

Following initial loading and organization of pills, most available pill boxes require the patient or caregiver to open a separate lid to access a single dose. With lid open, a patient will typically dig into the pill pocket with one or two fingers to extract the pills. Alternatively, the user may turn the entire pill box upside down to drop the correct dose into an open hand. The latter approach may be particularly important for patients who have limited dexterity or are losing their sense of touch. Turning an entire pill box upside down may be feasible for a compact pill box but is generally impracticable for large pill boxes.

As a result, many patients will prefer the visual clarity provided by a large pill box's greater number of apportioned doses, but will also need the physical benefits of a pill box which is compact in size and easy to handle. This forces a trade-off between simplicity and accuracy even though both are critical components of consistent medication adherence. This invention avoids such an untenable choice through advanced design, sound ergonomics and lean manufacturing methods.

The most common pill box now in use consists of a single row of seven individual pill storage pockets in a 1×7 array to accommodate a single dose for each day of a single week. While the 1×7 pill box is inexpensive and compact, it is not designed to accommodate the many millions of people who take two or more medications at two or more times per day. Consequently, patients who rely on the 1×7 pill box to organize their daily medications must exercise great care in loading the box each week and using the box to take the correct pills at the correct times, several times each day.

Pill box size, cost, and complexity will affect initial selection and consistent use over time. Superior ergonomic design is important to the specific act of taking each dose of each pill over the course of each day but, more fundamentally, is critical to the patient's willingness to use the pill box in the first instance. Flexible use must be designed into the pill box to accommodate users with differing needs regarding mobility, daily routines, and discreet inclusion of medication into their lives.

A pill box's design can also affect the chemical and physical stability of its contents. Superior design will strengthen the box's ability to withstand physical disruption (e.g., physical vibration and mechanical force) and environmental stressors (e.g., temperature extremes and water intrusion). Aesthetics will also be important to many users. Some users place a high degree of importance on the look of their accessories. Currently, commercially available pill boxes are limited in their ability to meet these and other needs of their potential users.

Remembering to take an indicated dose in a timely manner is an important component of medication adherence. In this regard, pillboxes with embedded electronics can provide valuable benefits. Some pill boxes will prompt, alarm, and notify users or caregivers who are located near the pill box. Other pill boxes rely on a dedicated communication line to provide connectivity to remote caregivers. However, these features come with a price. It is quite conceivable to lower pill box costs without losing these benefits by transferring some or all of these electronic functions to the standard electronics present in cell phones, tablets and other common electronic devices.

To date, efforts to improve medication adherence have been slow to incorporate and optimize the ready availability of digital photography, optical recognition and transmission of digital information. Digital cameras are pervasive in cell phones, laptops, tablets and other devices. Global sales of camera phones alone exceed 1 billion units per year. Camera phone users value high resolution photography as one of the most important features of their phones. Digital cameras have long been used and continue to be developed as an essential component of industrial production processes that rely on factory vision systems to attain 100% quality during fully automated manufacturing. Pill boxes can be designed to employ comprehensive vision system methods to capture valuable, real-time information which can then be easily transmitted to multiple users for the purpose of monitoring adherence and tracking patient response to medication.

At the community level and beyond; there are large and long-term medical networks in existence. These networks have a strong concern and stake in medication adherence. Central to their concern is a lack of adherence data to better analyze medication impacts. Specialists, organizations, caregivers, family members, and patients who have a stake in patient health recovery and the evolution of healthcare need better connectivity which provides improved data. The ongoing posting of data is needed to help discern relationships between the prescriptions of medication, patterns of patient consumption, observed and reported outcomes, and better patient outcomes. Finding ways to improve connectivity is a high priority for most community and globally based healthcare networks. One of the biggest challenges is to get diverse pill user data to then be able to compare patient differences, as would be the case with data from active patients and sedentary patients suffering from the same ailments.

At the present time, pill boxes are not optimized for easy loading, use, and refills. Physical and technological limitations in pill box design limit the ability to accommodate variations in user behavior patterns, preferences and lifestyles. Most significantly, existing pill boxes overlook or underutilize available methods for collecting, transmitting, and evaluating indications of proper adherence. As a result, clinically significant and real time data remain uncollected, unshared and unused. Each of these limitations presents a missed opportunity to improve medication adherence, improve patient outcomes, and recapture a sizeable portion of the hundreds of billions of dollars spent on the adverse consequences of poor adherence.

The scale of the medication adherence problem and the millions of people affected requires a dramatic improvement from the technologies of medication handling and tracking. These technologies must be provided to users at a low cost. The pill cup is where vast improvements in technology must begin. Pill cups are the ubiquitous centerpiece, which need to exist, side-by-side, with commodity electronics such as smart phones, and be integrated as complete systems with software.

### SUMMARY OF THE INVENTION

This invention overcomes many of the described limitations by providing a simple device and, without sacrificing simplicity; the invention incorporates technology to optimize the use of data for monitoring adherence and patient response to a prescribed medication protocol. The object of the invention is to create a complete and lean design for pill storage, organization, administration and monitoring. A per-dose pill cup with an open top side and optical markers is defined and identified as the new and essential element which provides ease of pill loading, storage, organization, and administration. To unblock the first act of taking medication, ergonomically designed per-dose pill cups ease the physical task of taking a dose, especially for patients or caregivers with limited dexterity, impaired cognition, co-morbidities or other limitations. To enhance the real world and multivariate use of medication, the pill cup can be held in trays and outer boxes of an almost limitless number of pill box types and continuous medication monitoring across different configurations is maintained. Many tray and outer box types have outer surfaces which match the edges and sides of the pill cups held therein and will form naturally interlocking and stacking shapes between multiple trays and boxes.

This invention's organizational layout is obvious to facilitate multiple medications with multiple doses to be quickly and easily loaded by the patient, provider, pharmacist or rotating caregivers. Pills are placed into a foundational configuration of individual and removable per-dose pill cups. Individual per-dose pill cups are placed onto locating features in outer, week-long, pill box trays. Together, each per-dose pill cup for seven days will form one row; all doses for one day will form one column. Thus, four doses per day for seven days per week will appear as four rows by seven columns within a single week-long tray. Each week-long tray has a single lid that closes with a secure, interlocking latch. Closing the lid prevents pills from slipping between pill cups or spilling if the overall tray is dropped. For users who prefer weekly loading, particularly for travel purposes, the week-long tray of correctly apportioned and organized doses can be used, as is.

A second and likely more common embodiment offers one of the invention's most important utility improvements: a physical assembly that permits a month's worth of multiple medications with multiple dosing regimens to be loaded and organized in a single sitting. Having the pharmacist or health care provider complete this process may offer numerous advantages by avoiding various sources of medication errors. Initial loading and organization of a full month's supply of pills can be efficiently accomplished by arranging each of five week-long trays, side-by-side, so that each dose of each day becomes one continuous row, with one column of doses per day. Because each week's tray has a single lid and five week-long trays comprise a full month, only five lids need to be opened to reveal a full month's worth of per-dose pill cups (as opposed to 120 lids per dose per day). Thus, to load and organize four doses per day for a full month at one time, the user simply opens five lids; drops pills for each dose in one, long horizontal row of pill cups; repeats this step for each additional dose; and closes the same five lids. This gives the patient an organized visual map to guide the process of consistent medication adherence throughout the month. As easily as the week-long trays can be set out side-by-side for quick loading, the trays can then be stacked for use as a single, stable and more compact month-long pill box.

As part of this second embodiment, a stack of five week-long pill box trays provides a more compact form of storage and minimizes its footprint on a kitchen or bathroom counter, dresser, bureau, table, or desk. The bottom of a week-long tray is designed to interlock with the lid of the tray beneath it, promoting overall stability. Once emptied, a week-long tray is moved to the bottom of the stack, making the next week's medications ready for use. A repositionable and distinctively colored “refill reminder” cup serves to alert the user of the need to refill medications without interrupting continuous medication adherence.

In a third embodiment, individual per-dose pill cups can be removed from the stacked pill box or weekly tray and can be placed into a separate and more compact box for daily use, travel or a special purpose. In a variation of this embodiment for pill transfer, individual per-dose pill cups can be removed from their original pill tray and can be poured into second pill cups in a second pill tray or pill box. The original pill cup is then returned to its original location in its original tray or box. As explained infra, photographic images can be taken of the second pill boxes and can be used with a software based photo analysis tool to confirm the integrity of dosage groupings.

In yet another embodiment, individual per-dose pill cups or trays of dissimilar sizes and shapes are placed into an outer box. This offers the benefit of storing and organizing varying pill sizes, shapes and volumes. Differences in size and shape of pill holders do not necessarily require differences among outer box locating and alignment features. For example, a given outer box and lid sized for the smallest pill cup could also fit, align, and hold larger pill cups without gaps between pill holders. This would be the case when pill cup length and width dimensions are a whole number multiple of the smallest pill cup length and width. Other features of larger pill cups are necessarily created in a complementary manner to avoid interferences with outer pill box features.

The invention defines improved utility for medication adherence across all embodiments with the inclusion of optical markers. The optical markers are used as fiduciary references in concert with digital photography, image recognition, and 3D reconstruction software; which are increasingly present as features of personal computers, tablets and other electronic devices such as cellphones. Integrating optical markers into the design and structure of each individual per-dose pill cup increases the precision and accuracy of analysis. The target for enhanced analysis of objects in the photographed field of vision is to reveal any issues that exist for proper pill presence and placement. Cameras used for this step can be fixed or free and picture taking can be actuated automatically or manually. The methods for analysis of pill cup contents from recorded images are known to those familiar with the art.

With sufficient photographic records, the optical markers in each per-dose pill cup provide reference information to determine the orientation, shape, color, shadowing, scale, markings and presence of pill boxes, pill trays, pill cups, and pills. The optical markers have known sizes, shapes, colors, locations, and a high degree of manufacturing precision. The best mode for optical markers is to be located adjacent and close to each dose of pills, and preferably on the same surface that supports the pills themselves. Close proximity helps to eliminate tolerance stack-up errors created across separate parts, greater distances, and any inconsistencies of less precisely formed optical markers.

An additional way to track medication adherence will be especially important to health care providers and pharmacists: photograph the pill box and simply check for pills present or absent. In most cases, it is reasonable to assume that “taking” or “not taking” any pill at any time is enough to signal larger problems with a patient's overall medication adherence. Such general information could alert the health care provider or pharmacist to conduct a closer investigation and implement a targeted intervention before nonadherence becomes clinically significant. Furthermore, full 3D reconstruction by individual pill type and dose is nevertheless available should circumstances warrant more detailed tracking over time.

Medication adherence and monitoring can be enhanced by applying lean manufacturing concepts to pill cup design. One example is to position a distinctively colored individual, per dose pill cup in the overall pill box on or close to the day when pills should be reordered from the pharmacy. Sequentially arriving at the distinctively colored “refill reminder” pill cup serves as a visual alert to refill a prescription by calling the pharmacy or prescribing doctor.

In summary, the invention's new pill storage and organization features provide multiple utilities by integrating ergonomic ease of use, lean manufacturing methods, known vision-system hardware elements, and image analysis software. The result is a defined basis for design to create pill box systems having: (a) low cost; (b) compact design; (c) intuitive ease of operation and use; (d) visual clarity and physical simplicity in the arrangement of pill doses; (e) efficient loading by provider, pharmacist, patient and rotating caregivers, (f) minimizing mistakes when pills are initially loaded and administered by multiple actors; (g) adaptations for different patterns of pill consumption, multiple medications and complex dosing regimens; (h) flexibility to accommodate changing user routines; (i) stability and tolerance for physical disruption, mechanical stressors and environmental exposures; (j) options for controls offered by lean manufacturing techniques; (k) electronic and logic based automation; (l) consistent digital generation and transmission of accurate data in real time, across different pill box configurations and embodiments; and (k) the opportunity for design elements with aesthetic appeal.

### BRIEF DESCRIPTION OF THE DRAWINGS

For a fuller understanding of the nature and objects of the invention, reference should be made to the following detailed description of a preferred mode of practicing the invention, read in connection with the accompanying drawings in which:

FIG. 1 shows perspective views of the best mode contemplated for a first embodiment of the present invention in the form of per-dose pill cups.

FIG. 2 shows a perspective view of an outer pill box for use with the first embodiment.

FIG. 3 shows a perspective view of an outer pill box with a complete array of individual per-dose pill cups.

FIG. 4 shows a perspective view of an outer pill box where “V” shaped outer pill box surfaces are positioned in tight alignment to pill cups held internally.

FIG. 5 shows a perspective view of pill boxes stacked.

FIG. 6 shows a perspective view of pill boxes or trays aligned for pill organization.

FIG. 7 shows a perspective view of per-dose pill cups being transferred between outer pill boxes.

FIG. 8 shows a perspective view of access via a primary door when opened and a method for pills being transferred via pouring between per-dose pill cups.

FIG. 9 shows a perspective view of the pill box in FIG. 8 with all doors closed

FIG. 10 shows a perspective view of a pill box with the primary door closed and access via a smaller door for a single per-dose pill cup.

FIG. 11 shows a perspective view of a pill box configuration with access via a primary door, no access with all doors closed, and access via a smaller door for a single per-dose pill cup.

FIG. 12 shows a perspective view for an alternate mode of the first embodiment for per-dose pill cups placed in a wide tray.

FIG. 13 shows the alternate pill cups of FIG. 12 placed into an outer box having a circular lid and bottom.

FIG. 14 shows a perspective view of compatible differences among dimensionally different per-dose pill cups.

FIG. 15 shows a perspective view of 2 fixed digital cameras adjacent to an array of per-dose pill cups.

FIG. 16 shows perspective views of optical markers located adjacent to storage pockets for pills in per-dose pill cups.

FIG. 17 shows a perspective view of an alternate color per-dose pill cup within a full array and an outer pill box.

### DETAILED DESCRIPTION OF THE INVENTION

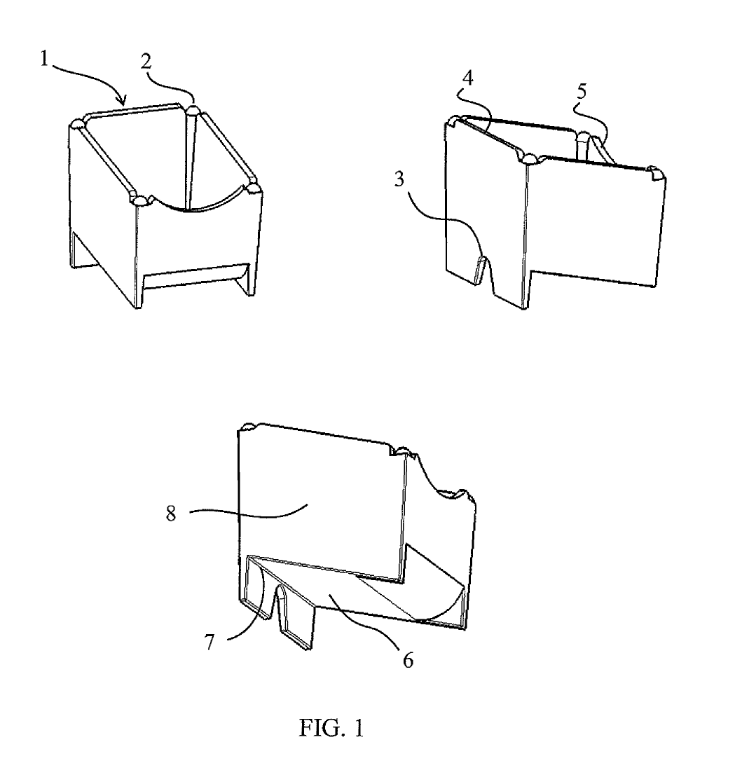

FIG. 1 illustrates a per-dose pill cup of the best mode contemplated for a first embodiment of the present invention. Pill cup 1 includes a bottom surface 6, a high side wall 4, a low side wall 5 approximately opposite high side wall 4, and side walls 8 comprising parallelogram shapes closing between high side wall 4 and low side wall 5. Pill cup 1 also includes mounting and locating features: bottom surface 6, inside corner 7, and pill cup locator 3. Bottom surface 6 is an oblique plane used as the pill cup mounting plane. Inside corner 7 is the “V” shaped vertex formed between oblique plane 6 and the second oblique plane forming the “V.” Inside corner 7 aligns the pill holder laterally on a tray or in an outer pill box. Pill cup locator 3 is comprised of angled edges resolving at their intersection as an angled vertex or a small radius, creating a feature for securing the lateral position of the pill box. Optimal manual handling of per-dose pill cups is enhanced by high side wall 4 in combination with low side wall 5 which, taken together, provide easy user gripping of high side wall 4 to lift, lower, and move pill holders around. Also, when pill cups are located immediately behind high side walls 4, the low side walls 5 of the pill cups on the aft side, open up more gripping area on high side walls 4. There is the possibility for additional gripping features on pill cups, the details of which are clear to those familiar with the art.

The top side of the per-dose pill cup is open. This is in direct distinction to the prior art for pill holders and pill boxes used for extended storage of pills. The prior art makes use of individual doors or enclosures closing the last open side of per-dose storage pockets. Also unique to the per-dose pill cup 1 is the presence of optical markers 2. Having a preferred shape as a portion of a spherical surface, optical markers 2 provide fiduciary references for analysis of per-dose pill cup contents when using image capture techniques.

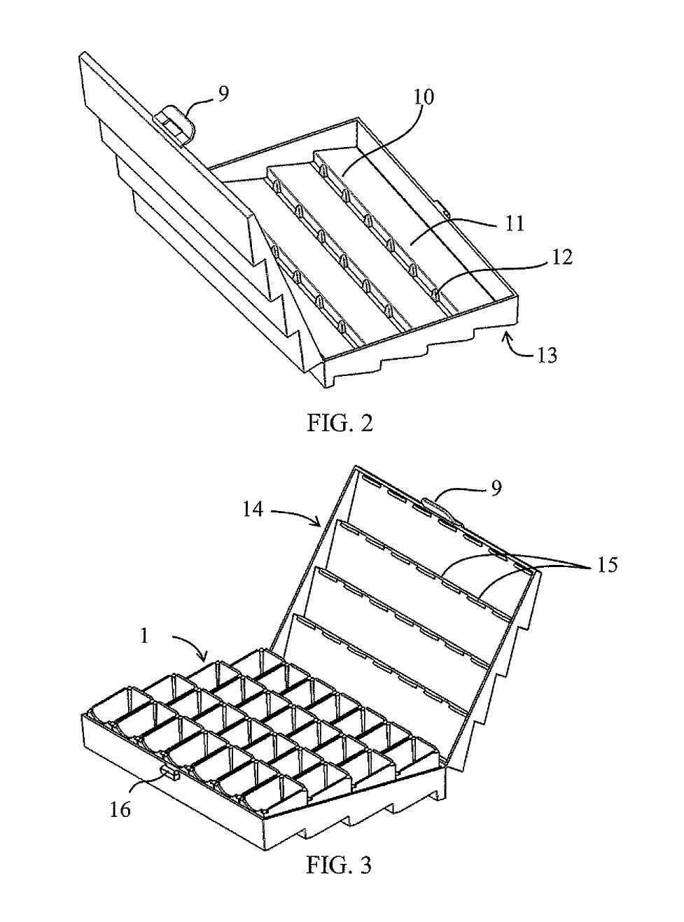

FIG. 2 illustrates corresponding mounting and locating features of a tray or an outer pill box 13 for positioning per-dose pill cups, 1. Locating and mounting features include support surface 11, mounting ridge 10, and pill cup locator 12. Support surface 11 is the oblique aligning plane which rests beneath pill cup surface 6. Mounting ridge 10 is an outside “V” shape which fits, coincident, with pill cup inside corner 7. Pill cup locators 12 are positioned on the second and intersecting oblique plane forming mounting ridge 10. Pill cup locators 12 are the male counterparts to locators 3 and locators 12 are the elements which divide an outer pill box 13 into a plurality of content holding sections, the elements of 12 being equidistant from one another and largely composed of triangular segments of material.

FIG. 3 illustrates an outer pill box 13 and a full array of per-dose pill cups 1, located inside and in place. Outer boxes and trays can have a cover 14. It is typical for a cover and box to have a hinge 17 and latching features 9 and 16 for opening and securely closing the box. The inner surfaces of the cover closely match the top edges of the per-dose pill cups 1. The inner surfaces of the cover 14 are comprised of oblique planes closely matched to the top edges of high wall 4 and side walls 8. The contoured edges 15 closely match the top edges of the low side walls 5. These features are interior elements to maintain pill cups in fixed positions when the cover is closed, even when as few as one pill cup is placed in an outer pill box.

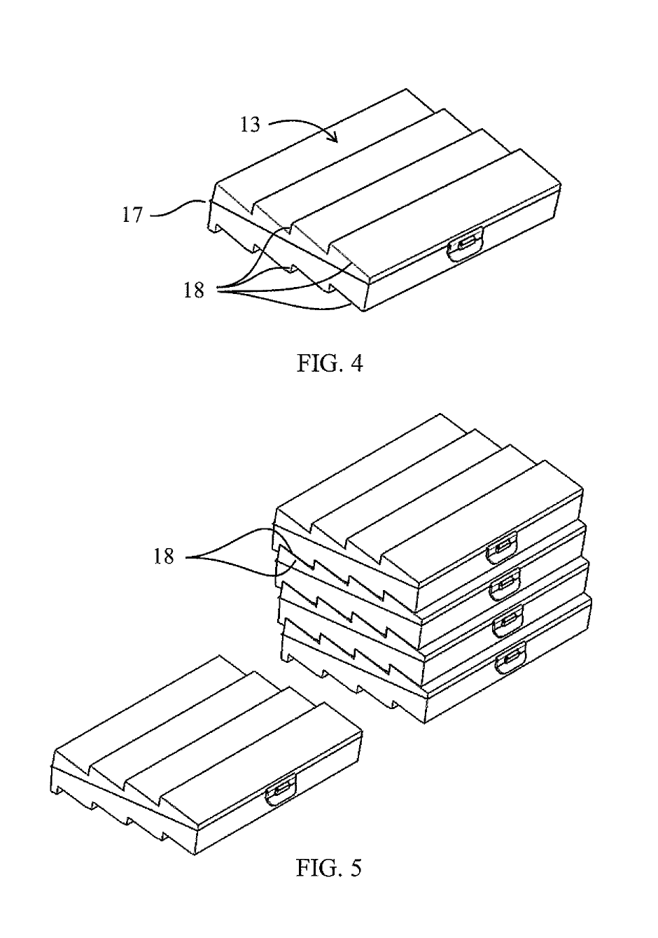

Additionally, cover 14 has inner surfaces matching the parallel oblique planes 18 of its outer cover surface, and is typically offset with a 2 mm or 3 mm wall thickness in between. The parallel oblique planes 18 shown in FIG. 4 assist the aligning and stacking of outer boxes, as shown in FIG. 5. Pills cannot move from one per-dose pill cup to another or out of the pill cup location where they reside when cover 14 closes over an outer pill box 13 and any number of per-dose pill cups 1. By design, gaps between the inside surface of cover 14 and pill cups 1 present in a pill tray or box are smaller than the smallest pills. It should be understood that there are other possibilities for pill cup aligning features which are not different in substance. Interior vertical pill box walls with pill cups that hook over the top edges would be an example. The disadvantage of this specific approach is the extra space taken from the lateral dimensions otherwise available for pill storage area and volume.

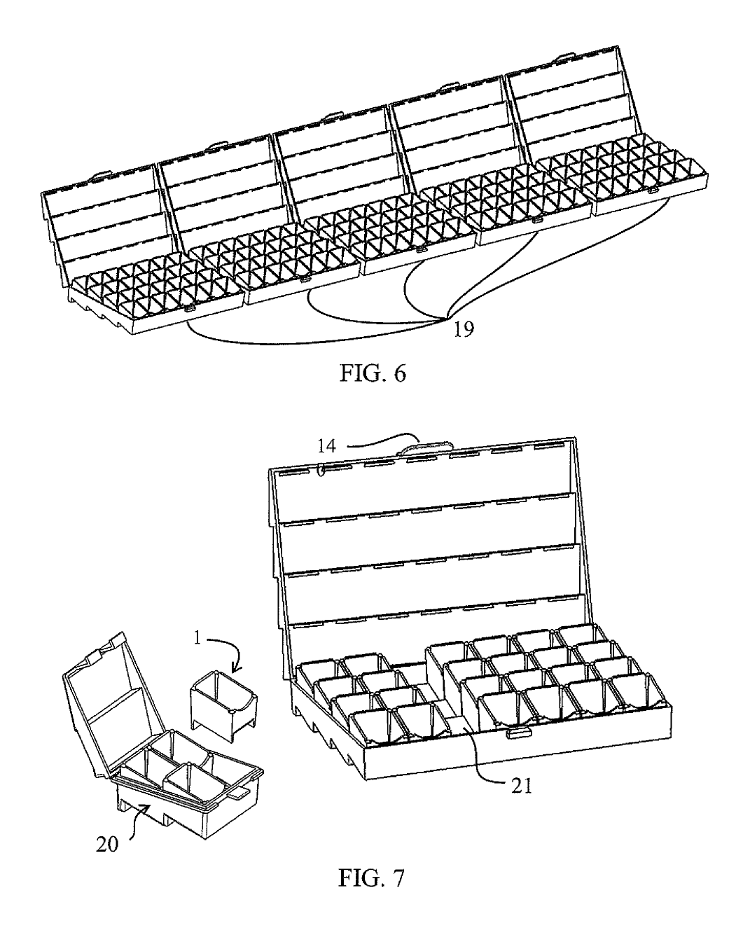

One of the great advantages as shown in FIG. 6 is that a plurality of outer pill boxes 13 can be quickly and easily opened and aligned for pill organization, with front bottom corners 19 in alignment. FIG. 6 shows a configuration that could match a patient's need for a pill box layout to organize 4 doses per day for up to 5 weeks. Arrays with close alignment between adjacent per-dose pill cups prevent pills from inadvertently being dropped in between pill cups. FIG. 5 shows that boxes can be closed and stacked just as quickly as the pill boxes can be opened and aligned. The parallel oblique planes 18 and the matching “V” shapes created between outer pill box tops and bottoms aid the stacking alignment and stability. Additional elements such as keying features or end walls can be added to secure against movement between boxes along the axis of the “V” intersection of parallel oblique planes 18 between stacked boxes.

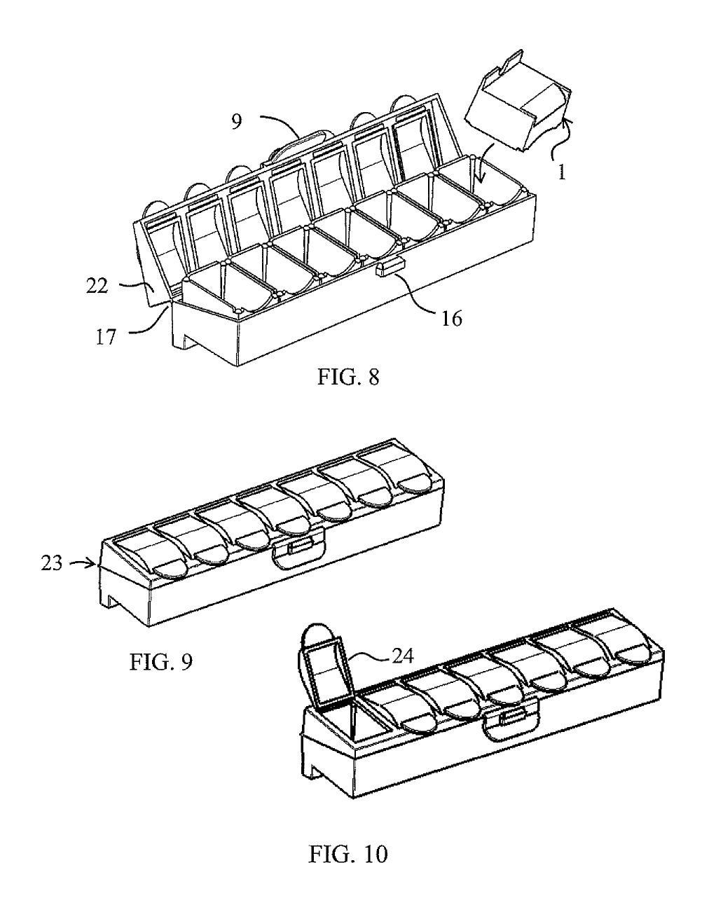

Outer pill boxes can be made for any array of individual pill cups 1. The choice of which outer pill box to use is left to the patient or caregiver. It is quite normal and expected that users will use more than one configuration. FIG. 7 shows pill cups being transferred from a larger outer pill box into one that is so constructed or configured that it is conveniently carried in the pocket or otherwise on the person of a user, and which has one or more compartments specifically arranged to hold per-dose pill cups. The box shown might be considered as a daily box 20. Pill cups can be easily selected and moved, leaving vacated positions 21. FIG. 8 shows an alternate method to transfer pills from one outer pill box to another. The tipped pill cup 1 pours a common dose of multiple pills into a waiting pill cup in a second outer pill box 23 that might be considered as a one-dose per day pill box for one week. The pill cup transferring pills is then returned to its location in the pill box from which it came.

FIG. 8, FIG. 9, and FIG. 10 also show consistency of basic features across outer pill box designs with a single cover 22, with hinge 17, and latching items 9 and 16. FIG. 9 and FIG. 10 highlight the possibility for small doors to be present on a cover 22. The small doors are similar to Dutch doors or half doors, popular in architecture and which provide for the alternatives of full or limited access. FIG. 10 shows a small door 24, which opens and closes the access to a single pill cup.

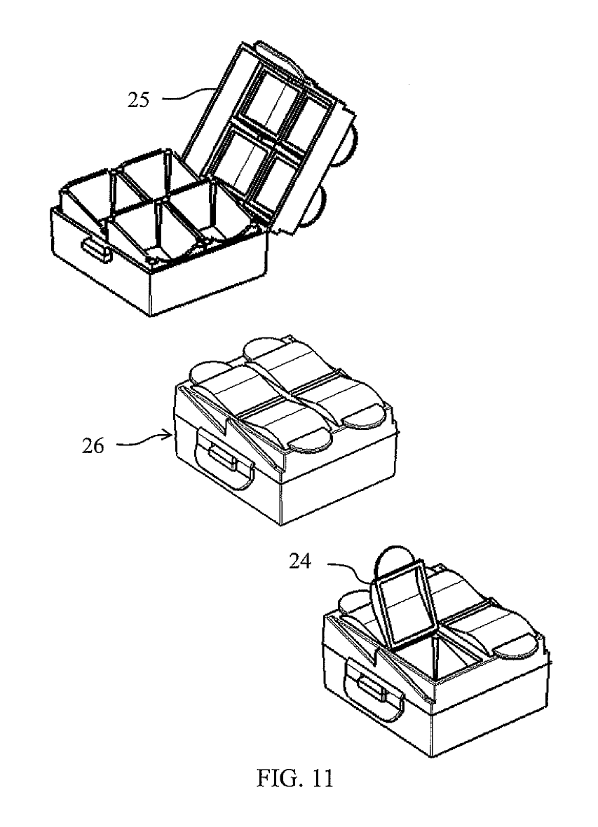

The outer pill box 23 is compact and when the small door 24 is open as shown in FIG. 10, the pill box can be turned upside down for a pill dose to fall into an open hand. FIG. 11 shows an alternative type of outer pill box 26. Cover 25 provides access to all per-dose pill cups while small door 24 provides access to a single pill holder. Like pill box 23, pill box 26 is compact and can be turned upside down for a pill dose to fall into an open hand.

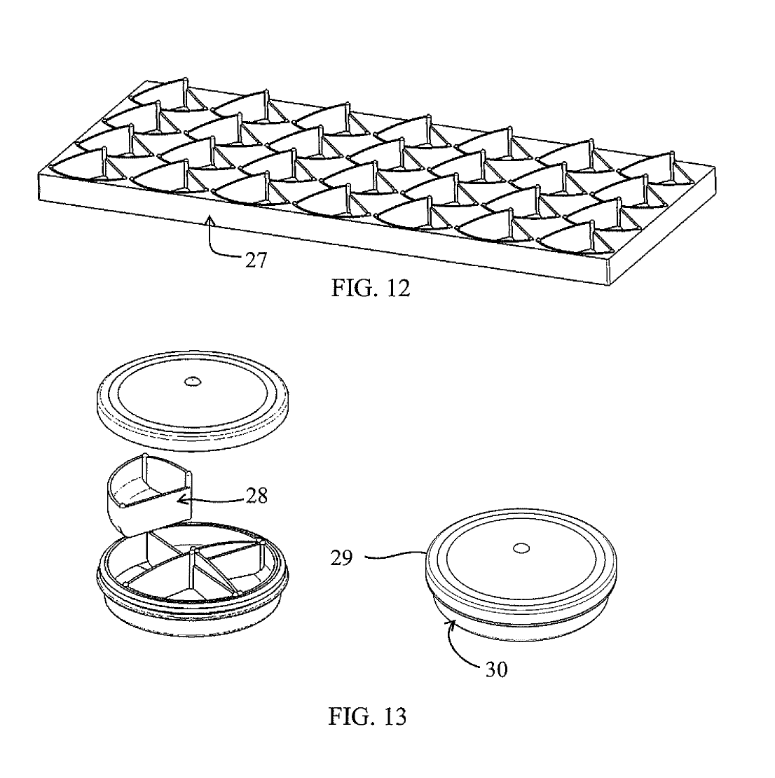

FIG. 12 shows an organizing tray 27 for per-dose pill cups 28 which differ in shape from the first embodiment. However, the same design guidelines are followed for the per-dose pill cups. There is a high side wall for gripping and a low side wall approximately opposite. The per-dose pill cups 28 have bottom surfaces with an intermateable shape which properly locates and aligns on the inside bottom surface of outer pill box 30 shown in FIG. 13. Pill box 30 is yet another outer pill box, with this one being circular in shape. The per-dose pill cup variation 28 can be used with a pill organizer tray 27 and pills can be poured or pill cups can be transferred individually to fill circular outer pill box 30. The screw or snap top 29 is a cap-like member to conformably engage, or to engage with a molded thread onto a round container bottom arranged for the same. This type of box can be made to seal against entry of water and keep the pill contents dry during full and deep submersion in liquids. While not shown, the convenience of moving pill cups or pills can be used to enable the easy transfer and use to a container with means to pad, brace, or hold the pill contents so that a blow or acceleration force will not damage said content.

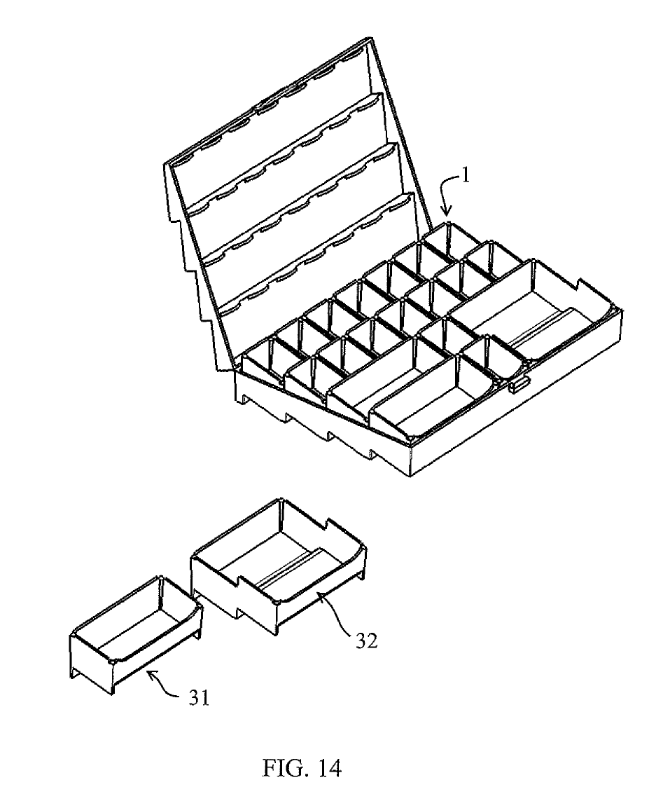

FIG. 14 shows how individual per-dose pill cups can be made at whole number multiples for length and width and be used in the same outer pill box which fits smaller pill holders. A 1×3 pill holder 31 and a 2×3 pill holder 32 are made by the same design guidelines described for pill holder 1. These pill holders of different sizes remain in tight alignment when positioned in an outer pill box.

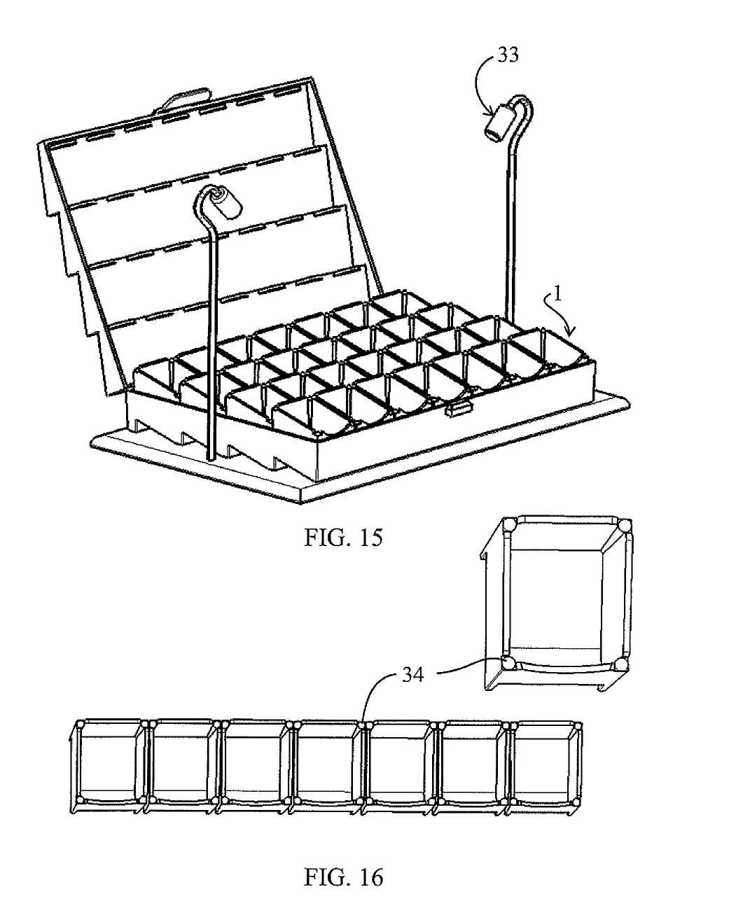

FIG. 15 shows 2 fixed digital cameras 33, positioned over a 4×7 array of individual per-dose pill cups. Two photos taken at angles to pill cups 1, which hold the objects to be analyzed, is a common and traditional method to record images which are then analyzed by software to gather information or to create a complete 3D reconstruction of pill holder contents. Newer image recording technology can capture images and create 3D reconstructions from a camera in a handheld sweeping motion as a scanned video.

The analysis of photographic snapshots or video is constructed from the given accuracy of the imaging device and how the images are recorded. Both the accuracy and precision of analysis are substantially enhanced when there are items in the field of camera vision which can be used for fiduciary reference. Certain items such as precision formed hemispheres provide the preferred form typically used as optical markers for fiduciary reference. FIG. 16 shows a typical field of vision view of individual pill cups to be photographed by a digital camera. The enlarged pill holder shows a close up view of optical markers 34. Optical markers as fiduciary references and all the known parameters of a pill cup as fiduciary references linked to optical markers, are used by analysis software where, (a) software can work from optical markers and prepare a complete 3D reconstruction of the entire photographed content; or (b) software can use the fiduciary reference of optical markers for accurate image recognition; or (c) software can use the optical markers to determine whether and from where a pill has been removed. These are all types of analysis which are known to those skilled in the art.

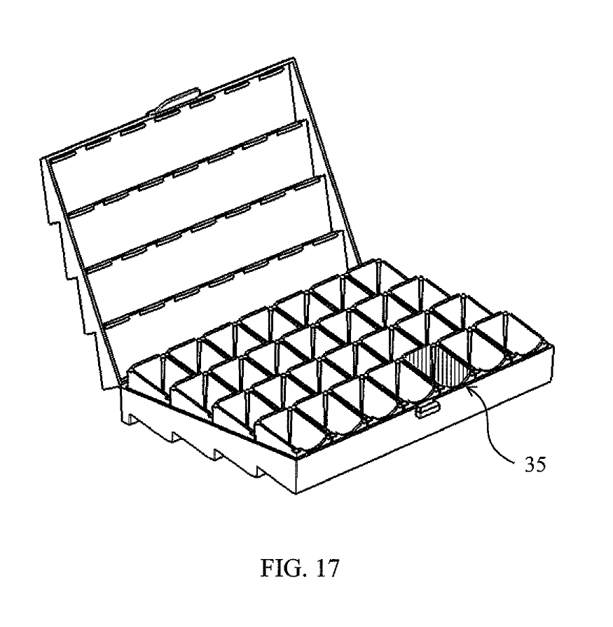

Pill boxes with multiple pill cups for pill storage create a visual map of separate doses matched to a day and a time. This kind of visual indicator is meant to prompt the action to take pills among users who are aware of the time and the day. This is a familiar type of visual indicator that can be found in lean manufacturing techniques. FIG. 17 shows another type of lean manufacturing indicator for an application of visual logic which is meant to trigger the placement of prescription refill orders. When a distinctively colored pill cup 35 is empty, it is time to refill or reorder medications for the coming months.

While the present invention has been particularly shown and described with reference to the preferred mode and some alternate modes, one skilled in the art will understand that various changes in detail may be effected therein without departing from the spirit and scope of the invention as defined by the claims.

What is claimed:

1. A pill cup or pill holder, comprising:
a storage vessel of a size appropriate for a dose of pills with
an open vessel top,
a high vessel side that fingers can grip,
a low side or sides approximately opposite the high vessel side,
and additional side walls to close in between.

2. The individual pill cup of claim 1, wherein the pill cup body has features for precise locating in a container such as a tray or outer box and with pill cup features comprising:
an oblique plane that establishes the pill cup height on the matching oblique mounting plane of a separate counterpart,
coincidence of inner and outer “V” shaped features formed by pairs of oblique planes on the pill cup and its outer counterpart,
and male to female locating features shared between the pill cup and the outer counterpart, such as triangular segments of material present on one and absent on the other.

3. Containers such as trays or outer boxes to be used with the pill cup of claim 1, wherein the containers precisely locating pill cups have features comprising:
an oblique plane which acts as the mounting plane for the pill cup and establishes the pill cup height in the container,
“V” shaped features formed by pairs of oblique planes to further and specifically position pill cup locations,
and male to female locating features shared between the per-dose pill cup and the container, such as triangular segments of material present on one and absent on the other.

4. Containers such as trays or outer boxes to be used with the pill cups of claim 1, wherein the containers have covers with oblique planes and features to match the top side profiles of per-dose pill cup arrays such that there are no gaps between cover and pill cup top edges which are bigger than the smallest pill thickness therein and outer surfaces comprising:
paired oblique planes forming “V” shapes set parallel and at constant offsets between container bottom and cover tops,
which enable stacking of covered containers,
and may include keying features to further align the stack.

5. Containers such as trays or outer boxes to be used with the pill cups of claim 1, wherein the containers have hinged and latched covers comprising:
a single cover that spans the entire per-dose pill cup array,
with internal walls to closely match the top edges of per-dose pill cup arrays,
and individual latched doors on the same cover to provide access to per-dose pill cups.

6. Containers such as trays or outer boxes to be used with the pill cup of claim 1 to accomplish user valued benefits, such as waterproof storage and other attributes typical to container art.

7. The use of optical markers within the field of vision of recorded images, such as photographs, to be used for analysis of pills in pill boxes, where optical markers are comprised of:
smooth and dimensionally known shapes such as spherical surfaces,
which are molded or formed with precision.

8. The inclusion of optical markers of claim 7 on pill cups comprised of:
known dimensions and known manufacturing precision with
optical markers placed in known and favorable positions for camera field of vision recording.
